(19) United States
(12) Patent Application Publication
(10) Pub. No.: US 2024/0317184 A1
(43) Pub. Date: Sep. 26, 2024

(54) METHOD FOR CLEANING MOTOR VEHICLE SURFACES

(71) Applicant: VALEO SYSTEMES D'ESSUYAGE, La Verriere (FR)

(72) Inventors: Yoann DOLLE, La Verriere (FR); Denis THEBAULT, La Verriere (FR); Adrien PERET, La Verriere (FR); Maxime BAUDOUIN, La Verriere (FR); Giuseppe GRASSO, La Verriere (FR)

(73) Assignee: VALEO SYSTEMES D'ESSUYAGE, La Verriere (FR)

(21) Appl. No.: 18/260,946

(22) PCT Filed: Jan. 26, 2022
(86) PCT No.: PCT/EP2022/051685

§ 371 Date: Jul. 11, 2023

(30) Foreign Application Priority Data
Feb. 1, 2021 (FR) 2100927

(51) Int. Cl. B60S 1/48; B60S 1/50; B60S 1/52

(52) U.S. Cl. CPC B60S 1/481; B60S 1/50; B60S 1/52

(57) ABSTRACT

A method for cleaning motor vehicle surfaces with the aid of a cleaning device comprising a reservoir of cleaning liquid, at least one nozzle for spraying cleaning liquid, a fluid distribution circuit conveying cleaning liquid from the reservoir to the cleaning nozzle, and a pump injecting the cleaning liquid contained in the reservoir into the fluid distribution circuit, the fluid distribution circuit comprising a cleaning liquid distribution unit comprising a plurality of valves connected to the nozzle, the method comprising the following steps: starting the pump to inject the cleaning liquid into the distribution unit, opening a plurality of the valves connected to the nozzle depending on the desired pressure at the outlet of the nozzle, and spraying cleaning liquid from the nozzle onto a surface to be cleaned.

### TECHNICAL FIELD

The invention relates to devices for cleaning a surface of a motor vehicle and which are intended to be carried on board a motor vehicle.

### BACKGROUND OF THE INVENTION

Numerous surfaces, for example sensors of motor vehicles, may be subjected to various types of dirtiness. They include for example the various driver assistance cameras or the distance sensors, ultrasonic sensors, radars, LIDAR sensors or rain sensors placed on the vehicle.

Now, this dirtiness may cause certain devices to malfunction or cause a user of the vehicle to begin to experience difficulties (lack of visibility because of dirt on the windshield). It is therefore necessary to provide a device for cleaning these surfaces.

Conventionally, such cleaning devices are made up of a reservoir in which cleaning liquid is stored, and a fluid distribution circuit made up of various pipes or tubes that make it possible to convey the cleaning liquid to at least one cleaning nozzle placed in front of a surface so as to spray cleaning liquid onto it (as a general rule, there are a plurality of cleaning nozzles for a plurality of surfaces).

A pump intended to propel the cleaning liquid in the fluid distribution circuit as far as the cleaning nozzle is generally mounted directly on the reservoir. More specifically, a liquid intake tube of the pump is forced-fitted into an opening made in the reservoir (a seal is used to ensure that the assembly is leaktight), and the liquid discharge orifice is, for its part, connected to the fluid distribution circuit

When the malfunctioning of a sensor due to the presence of dirt is detected (automatically, for example), or when the user operates a command to activate the cleaning device, the pump draws cleaning liquid from the reservoir, the liquid being at a similar pressure to atmospheric pressure (the pressure depends on the head of cleaning liquid in the reservoir), and propels it into the fluid distribution circuit at a higher pressure (the pressure difference depends on the capacity of the pump). The pressurized cleaning fluid is sprayed onto the sensor by the cleaning nozzle

However, such devices may have a drawback in terms of cleaning performance.

Specifically, it is found that there are pressure drops which are dependent on the distance between the pump and the cleaning nozzles. This distance varies according to the position of the cleaning nozzles on the vehicle. It is therefore possible that the cleaning of a surface will not be effective because of the excessively low pressure of the cleaning liquid as it exits the cleaning nozzle

It would be possible to add pumps, for example as many as there are nozzles (or even several reservoirs of cleaning liquid) and to site these relatively close to the cleaning nozzles. However, the architecture that would result from this decision would be complex, and its production and maintenance costs would be high.

It is a notable objective of the invention to provide a method for cleaning motor-vehicle surfaces that is able to overcome the following problems, both in terms of minimizing the pressure drops and in terms of the possibility of implementing it using a cleaning device of simple architecture.

### SUMMARY OF THE INVENTION

To that end, the invention relates to a method for cleaning motor vehicle surfaces using a cleaning device comprising a reservoir of cleaning liquid, at least one nozzle for spraying the cleaning liquid, a fluid distribution circuit designed to convey the cleaning liquid from the reservoir to the cleaning nozzle and a pump designed to inject the cleaning liquid contained in the reservoir into the fluid distribution circuit, the fluid distribution circuit comprising a cleaning liquid distribution block fluidically connected to the pump and comprising several valves having substantially identical flow rates, the nozzle being connected to several valves of the distribution block, the method comprising the following steps:
commanding operation of the pump to inject the cleaning liquid contained in the reservoir as far as the distribution block,
commanding the opening of several of the valves connected to the nozzle according to the desired pressure at the outlet of the nozzle and when the pressure at the inlet of the distribution block has reached a predetermined pressure, and
spraying cleaning liquid from the nozzle onto a surface that is to be cleaned.

This then yields a method in which the pressure drops are limited or even eliminated. First of all, the presence of valves in the fluidic distribution circuit makes it possible to create an intermediate stage-level that allows activation to be performed in two phases, with the pump being activated in a first phase and the valves then opened when the pressure at the inlet of the distribution block is satisfactory. This then reduces the length of the path that the cleaning liquid follows without obstacle and therefore with appreciable pressure drop, creating a compression stage.

In addition, and by dividing the flow of liquid destined for the nozzle between several valves, the total flow rate entering the distribution block is divided by the number of valves connected to the nozzle. The pressure drops in each valve are markedly lower than they would be with the use of a single valve. It is therefore possible to open some of the valves connected to a nozzle (several valves) or all of these valves in order to limit the pressure drops involved in passing through the distribution block. The pressure drops are limited still further by adopting this approach. It is even possible to choose the pressure that is to be obtained at the outlet of the nozzle by choosing the number of valves connected to the nozzle that are to be opened.

It is therefore possible to influence the pressure drops and, more generally, the pressure at the cleaning nozzles, while using standard components.

According to further optional features of the cleaning system, taken individually or in combination:
the number of valves opened is dependent on the distance between the nozzle that is connected to several valves and the distribution block. Thus, the further a cleaning nozzle is away from the distribution block, the higher the number of valves that can be opened to ensure pressure drops that are as low as possible;
The number of valves opened is dependent on the surrounding temperature. It is possible to compensate for greater pressure drops in the event of low temperatures by opening a greater number of valves connected to a cleaning nozzle;
All the valves are opened upon the command to open the valves connected to the nozzle. This then reduces pressure drops as far as possible.
The cleaning method further comprises the following steps:
activating the pump, with the valves closed, and
opening the valves.

This then creates a compression stage-level in a segment of the fluid distribution circuit situated between the pump and the distribution block. This then limits pressure drops;
The cleaning device comprises a control unit connected to the distribution block and configured to command the opening and closing of the set of valves;
The control unit commands the opening of a number of valves that differs according to the desired pressure at the outlet of the cleaning nozzle;
The cleaning device comprises several nozzles, each nozzle being connected to a set of valves, the method comprising a command to open several valves of each set of valves after the step of commanding operation of the pump in order to inject the cleaning liquid contained in the reservoir as far as the distribution block;
The valves are configured to have an outlet metric flow rate of between 0.12 and 0.15 m3/h; and
The valves are solenoid valves.

### BRIEF DESCRIPTION OF THE DRAWINGS

The invention will be better understood on reading the following description, provided purely by way of example and with reference to the appended drawings, in which:

FIG. 1 is a schematic representation of a portion of a cleaning device according to the invention, and

FIG. 2 is a depiction, in the form of a graph, illustrating the pressure drops as liquid passes through one or more valves as a function of the flow rate at which it enters the valve or valves.

### DETAILED DESCRIPTION OF THE INVENTION

The embodiments described with reference to the figures are examples. Although the description refers to one or more embodiments, this does not necessarily mean that each reference relates to the same embodiment, or that the features apply only to one single embodiment. Individual features of various embodiments may also be combined to create other embodiments.

The terms “upstream” and “downstream” are used to locate the elements/devices in the direction in which the stream of substance to be handled is being transported. A first device or element, for example a pump, is thus situated upstream of a second device or element if the substance is handled first by the first device and then by the second device.

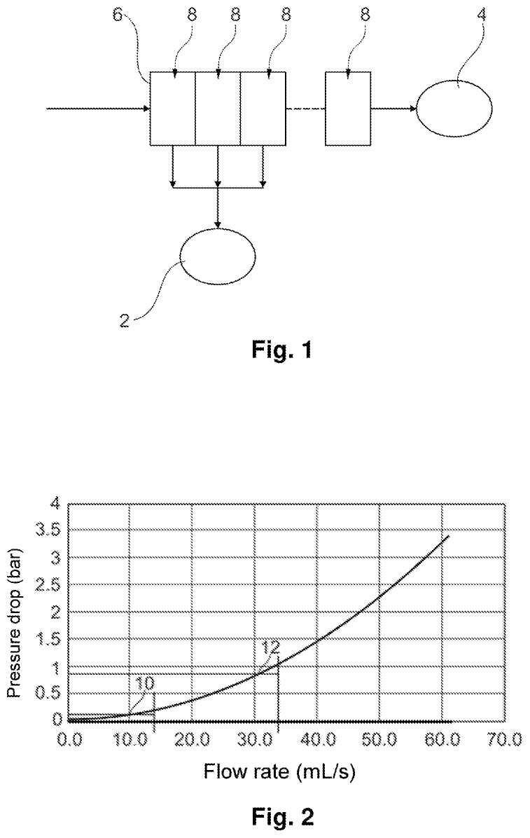

Reference is now made to FIG. 1 which illustrates a fraction of a cleaning device according to the invention. The aim of this cleaning system is to make it possible to clean various surfaces of the motor vehicle such as, for example, sensors carried on board the vehicle, or the windshield or rear window.

Such a cleaning device comprises a reservoir of cleaning liquid (not depicted in the figures) on which there is mounted a pump (which is not depicted in the drawings). The pump is mounted in a recess of the reservoir intended for accommodating the pump, the reservoir comprising an orifice through which an intake tube of the pump is mounted, with a seal at the interface between the reservoir and the pump around the orifice in order to ensure that the assembly is leaktight. As is conventional, the pump is a standard pump comprising a tubular main body for example. This main body can be made up of a pumping first portion and a driving second portion comprising an electric motor. The pumping first portion comprises a liquid intake tube and a liquid discharge tube so that it can receive cleaning liquid from the reservoir and discharge it at a higher pressure than the intake pressure of the pump. The liquid intake tube can be placed at a free end of the pumping first portion and be coaxial with the main body of the pump, sharing the same axis of revolution as it. The discharging second portion can extend from the pumping first portion in a direction perpendicular to the axis of revolution of the main body.

The driving second portion can be situated above the pumping first portion and comprise an electric motor and, at its free end, a connector making it possible to connect the pump to an electrical power source.

A plurality of cleaning nozzles 2 and 4 may be fitted and are situated at the other end of the cleaning device and intended to be placed in front of a surface of the motor vehicle to be cleaned in order to spray pressurized cleaning liquid onto it.

The cleaning device further comprises pipes (or piping) connecting the different members (pump, cleaning nozzles 2 and 4, etc.) to each other to form a fluid distribution circuit.

The cleaning device further comprises a cleaning liquid distribution block 6 comprising several valves 8 (four are depicted in this instance). The pump is configured to pump the washing liquid from the reservoir and send it to the distribution block 6 and the cleaning nozzles 2 and 4.

The valves 8 of the distribution block 6 are configured to be fluidically connected respectively to the nozzles. At least one nozzle, in this instance the nozzle 2, is connected to several valves, three valves in FIG. 1. The number of nozzles connected to several valves may of course vary, just as may the number of valves connected to one nozzle.

The valves 8 are configured to selectively transmit the pumped washing liquid to the associated cleaning nozzles. The valves 8 are, for example, solenoid valves conventionally used in this type of cleaning device. The valves 8 may be arranged in parallel, meaning that they are all connected to one fluidic channel of the distribution block 6. This fluidic channel is connected to an inlet of the distribution block 6, which inlet is connected to the pump. An outlet of the distribution block 6 may itself be blanked off by a cap. Alternatively, it is possible to provide at the outlet of the distribution block 6 a return-to-reservoir line returning liquid to the reservoir and having an overpressure valve.

The valves 8 have substantially identical flow rates. This again demonstrates a desire for standardization by using valves having the same specifications or very similar specifications. By way of example, the valves 8 have flow rates that differ from one another by 5% at most. By way of example, the valves 8 are configured to have a nominal outlet metric flow rate of between 0.12 and 0.15 m3/h.

Thus, in operation, the activation of the pump makes it possible to transmit the washing liquid from the reservoir toward the distribution block 6 and toward the cleaning nozzles the associated valve or valves 8 of which are open.

The distribution block 6 is a modular block and so the number of valves 8 can easily be modified to adapt it to suit the number of cleaning nozzles, or to suit a particular configuration of the cleaning device, for example depending on the model of the motor vehicle if the cleaning device is mounted on a motor vehicle. Different distribution blocks 6 can also be combined.

As regards the method for cleaning a surface using the nozzle 4, this involves activating the pump then opening the valve 8 so as to spray cleaning liquid through the cleaning nozzle 4.

As regards the method for cleaning using the nozzle 2, the first step is also that of commanding operation of the pump to inject the cleaning liquid contained in the reservoir as far as the distribution block 6. It is possible for the valves 8 connecting the pump to the nozzle 2 to be closed, so as to pressurize the segment of the fluid distribution circuit comprised between the pump and the distribution block 6, until a maximum pressure is reached (and the same is true of the nozzle 4). Doing that creates a compression stage-level in the segment upstream of the distribution block 6 and thus makes it possible to limit the pressure drops in the fluid distribution circuit.

The second step corresponds to commanding the opening of several of the valves connected to the nozzle according to the desired pressure at the outlet of the nozzle and when the pressure at the inlet of the distribution block has reached a predetermined (maximum, as explained hereinabove, or intermediate) pressure. The number of valves 8 opened may vary according to certain parameters, as will be seen later on.

The passage of the liquid through several valves 8 makes it possible to minimize the pressure drops as illustrated in FIG. 2 which represents the pressure drops (ordinate axis) as a function of the flow rate at the inlet of the valve 8 (abscissa axis). Specifically, and for valves used in the conventional way for this type of application, the liquid flow rate at the valve inlet when just one single valve is used is approximately 30 milliliters per second. The pressure drop is then approximately 0.9 bar, as may be seen from point 12 on the curve of FIG. 2.

By contrast, when for example three valves are opened in order to pass the same quantity of liquid under the same conditions, this liquid is split between the three valves and the flow rate at the inlet to each valve is divided by three, becoming 10 milliliters per second. The pressure drop is then approximately 0.1 bar, as may be seen from point 10 on the curve of FIG. 2. That then allows a very significant reduction in the pressure drops on passing through the distribution block 6.

The action of modulating the number of valves that are connected to a nozzle and the number of valves that are opened makes it possible to modulate the pressure at the outlet of the distribution block and thus modulate the pressure at the outlet of the nozzles, for example so as to have the highest possible pressure at the nozzle outlet. It is also possible to envision several cleaning modes for cleaning a surface, for example dependent on the level of dirtiness of this surface, by varying the number of valves 8 opened. Thus, by opening a greater or lesser number of valves 8 connected to the nozzle 2, the pressure at the outlet of the nozzle 2 would differ, and this would correspond to different washing modes.

The cleaning liquid can thus reach the nozzle 2 and be sprayed onto a surface that is to be cleaned.

As a preference, the number of valves 8 opened is dependent on the distance between the nozzle 2 that is connected to several valves 8 and the distribution block 6. Specifically, and in order to avoid pressure drops affecting a nozzle, for example the nozzle 2 distant from the distribution block 6, it is possible to assign a high number of valves 8 to it and to open all of them in order to maximize the extent to which the pressure drops along the fluid distribution circuit are limited, as explained hereinabove by splitting the cleaning liquid between the valves 8. It is therefore possible to have several nozzles situated at different distances from the fluid distribution block 6, each nozzle being connected to a different number of valves 8 according to its distance. For example, the nozzle 4, connected to a single valve 8, may therefore be closer to the distribution block 6 than the nozzle 2 which is connected to three valves 8 and for which the potential pressure drops are greater.

It is also possible for the number of valves 8 opened to be dependent on the surrounding temperature. Specifically, a lower temperature leads to an increase in the pressure drops. As a result, it is possible to open a greater number of valves when the temperature is lower, to ensure that the pressure drops are minimized as fully as possible.

It is also possible for all the valves 8 to be opened upon the command to open the valves 8 connected to the nozzle 2. This then results in a maximum pressure at the outlet of the nozzle 2. As explained above, it is possible to open just some of the valves 8 connected to the nozzle 2, for example for the reasons mentioned hereinabove.

The cleaning device may comprise a control unit connected to the distribution block 6 and configured to command the opening and closing of the set of valves 8. That allows these commands to be centralized and allows the various valve-opening dynamics described above to be set in place.

The control unit may command the opening of a number of valves 8 that differs according to the desired pressure at the outlet of the cleaning nozzle. A concrete example of the various possibilities regarding the opening of valves 8 of the distribution block 6 has been given here.

As explained above, the cleaning device may comprise several nozzles, each nozzle being connected to a set of valves 8, the method comprising a command to open several valves 8 of each set of valves after the step of commanding operation of the pump in order to inject the cleaning liquid contained in the reservoir as far as the distribution block 6. The number of valves 8 that are connected to a nozzle may be different, notably according to the parameters examined above (distance between the nozzle and the distribution block 6, the ability to implement several different washing modes, etc.).

### LIST OF REFERENCES

2, 4: cleaning nozzles
6: cleaning-liquid distribution block
8: valves
10: point illustrating the pressure drops for an inlet flow rate of 10 mL/s
12: point illustrating the pressure drops for an inlet flow rate of 30 mL/s

What is claimed is:

1. A method for cleaning motor vehicle surfaces using a cleaning device comprising a reservoir of cleaning liquid, at least one nozzle for spraying the cleaning liquid, a fluid distribution circuit designed to convey the cleaning liquid from the reservoir to the cleaning nozzle and a pump designed to inject the cleaning liquid contained in the reservoir into the fluid distribution circuit, the fluid distribution circuit comprising a cleaning liquid distribution block comprising several valves having substantially identical flow rates, the nozzle being connected to several valves of the distribution block, the method being characterized in that it comprises the following steps:
commanding operation of the pump to inject the cleaning liquid contained in the reservoir as far as the distribution block,
commanding the opening of several of the valves connected to the nozzle according to the desired pressure at the outlet of the nozzle and when the pressure at the inlet of the distribution block has reached a predetermined pressure, and
spraying cleaning liquid from the nozzle onto a surface that is to be cleaned.

2. The cleaning method as claimed in claim 1, wherein the number of valves opened is dependent on the distance between the nozzle that is connected to several valves and the distribution block.

3. The cleaning method as claimed in claim 1, wherein the number of valves opened is dependent on the surrounding temperature.

4. The cleaning method as claimed in claim 1, wherein all the valves are opened upon the command to open the valves connected to the nozzle.

5. The cleaning method as claimed in claim 1, further comprising the following steps of:
activating the pump, with the valves closed, and
opening the valves.

6. The cleaning method as claimed in claim 1, the cleaning device comprising a control unit connected to the distribution block and configured to command the opening and closing of the set of valves.

7. The cleaning method as claimed in claim 6, wherein the control unit commands the opening of a number of valves that differs according to the desired pressure at the outlet of the cleaning nozzle.

8. The cleaning method as claimed in claim 1, the cleaning device comprising several nozzles, wherein each nozzle is connected to a set of valves, the method comprising a command to open several valves of each set of valves after the step of commanding operation of the pump in order to inject the cleaning liquid contained in the reservoir as far as the distribution block.

9. The cleaning method as claimed in claim 1, wherein the valves are configured to have an outlet metric flow rate of between 0.12 and 0.15 m3/h.

10. The cleaning method as claimed in claim 1, wherein the valves are solenoid valves.
